(19) United States
(12) Patent Application Publication
(10) Pub. No.: US 2022/0239002 A1
(43) Pub. Date: Jul. 28, 2022

(54) ANTENNA APPARATUS AND FEED NETWORK THEREOF

(71) Applicant: ELECTRONICS AND TELECOMMUNICATIONS RESEARCH INSTITUTE, Daejeon (KR)

(72) Inventor: Soon Young EOM, Daejeon (KR)

(73) Assignee: ELECTRONICS AND TELECOMMUNICATIONS RESEARCH INSTITUTE, Daejeon (KR)

(21) Appl. No.: 17/581,319

(22) Filed: Jan. 21, 2022

(30) Foreign Application Priority Data
Jan. 25, 2021 (KR) 10-2021-0010209

(51) Int. Cl. H01Q 9/18; H01Q 15/24

(52) U.S. Cl. CPC H01Q 9/18; H01Q 15/24

(57) ABSTRACT

An antenna apparatus may be disclosed. The antenna apparatus may include a feed network including a plurality of first internal transmission lines arranged in a cross form and a plurality of second internal transmission lines arranged in a ring form around the plurality of first internal transmission lines; and a plurality of radiation elements positioned around the feed network and radiating signals fed by the feed network.

### CROSS-REFERENCE TO RELATED APPLICATION

This application claims priority to and the benefit of Korean Patent Application No. 10-2021-0010209 filed in the Korean Intellectual Property Office on Jan. 25, 2021, the entire contents of which are incorporated herein by reference.

### BACKGROUND OF THE INVENTION

### (a) Field of the Invention

The present disclosure relates to an antenna apparatus and a feed network thereof.

### (b) Description of the Related Art

Antenna apparatuses generating dual-orthogonal circular polarization may be implemented in various forms. A phase difference of a dual-orthogonal component is generated in a single radiation element through an artificial transformation (e.g., a slot is placed at the center) to generate dual circular polarization. However, the antenna apparatus having such a structure has a low antenna gain, and a narrow band property in which an input matching and axial ratio property is within approximately 3%. In addition, there is an antenna apparatus structure constituted by the single radiation element and a 90° hybrid combiner. The structure performs dual-orthogonal feed by using a circuit operation property of the 90° hybrid combiner to generate the dual circular polarization. Such a structure also has the low antenna gain and operates in a band in which the input matching and axial ratio property is approximately 10%.

Meanwhile, there is an antenna apparatus generating single circular polarization by using four radiation elements. The antenna apparatus generating the circular polarization by using four radiation elements may increase the antenna gain through adjustment of an arrangement interval among four radiation elements, and improve the axial ratio property in a wide observation angle area. However, different feed networks are required for generating the dual-orthogonal circular polarization through the antenna apparatus generating the single circular polarization.

The above information disclosed in this Background section is only for enhancement of understanding of the background of the invention, and therefore it may contain information that does not form the prior art that is already known in this country to a person of ordinary skill in the art.

### SUMMARY OF THE INVENTION

At least one exemplary embodiment among exemplary embodiments may provide an antenna apparatus capable of generating dual-orthogonal polarization by a single feed network

An exemplary embodiment of the present invention may provide an antenna apparatus. The antenna apparatus may include: a feed network including a plurality of first internal transmission lines arranged in a cross form and a plurality of second internal transmission lines arranged in a ring form around the plurality of first internal transmission lines; and a plurality of radiation elements positioned around the feed network and radiating signals fed by the feed network.

The number of plurality of first internal transmission lines may be at least 4 and the number of plurality of second internal transmission lines may be at least 8, and the number of input ports of the feed network may be at least 2 and the number of output ports of the feed network may be at least 4.

Each internal transmission line included in the plurality of first internal transmission lines and the plurality of second internal transmission lines may have a first property impedance and a predetermined electrical length.

The feed network may further include an input transmission line connected to the input port and an output transmission line connected to the output port.

The input transmission line and the output transmission line may have a second property impedance, and the first property impedance may be twice larger than the second property impedance, and the predetermined electrical length may be 90°.

A first input signal corresponding to a right-handed circular polarization may be input into a first input port of the at least two input ports, and a second input signal corresponding to a left-handed circular polarization may be input into a second input port of the at least two input ports.

At least one output port of the at least four output ports may be positioned between the first input port and the second input port.

The number of plurality of radiation elements may be at least 4, and the antenna apparatus may further include at least four transmission lines connected to each of the at least four output ports and each of the at least four radiation elements.

Two transmission lines of the at least four transmission lines may be transmission lines having a phase delay of 0° and two remaining transmission lines may be transmission lines having a phase delay of 90°.

The feed network may be formed on a first printed circuit board, the plurality of radiation elements may be formed on a second printed circuit board, and the second printed circuit board may be formed to be erected perpendicular to the first printed circuit board.

Another exemplary embodiment of the present invention may provide a feed network providing feed signals to a plurality of radiation elements. The feed network may include: a first input port into which a first signal is input; a second input port into which a second signal is input; a plurality of first internal transmission lines arranged in a cross form; a plurality of second internal transmission lines arranged around the plurality of first internal transmission lines; and a plurality of output ports providing feed signals to the plurality of radiation elements, respectively.

In the plurality of first internal transmission lines, an internal transmission line corresponding to one line and an internal transmission line corresponding to the remaining line constituting the cross form may not be connected to each other, but may cross.

The number of plurality of first internal transmission line may be at least 4 and the number of plurality of second internal transmission lines may be at least 8, the number of plurality of output ports may be at least 4, and the number of plurality of radiation elements may be at least 4.

The feed network may further include: a first input transmission line connected to the first input port; a second input transmission line connected to the second input port; and a plurality of output transmission lines connected to the plurality of output ports, respectively.

Each internal transmission line included in the plurality of first internal transmission lines and the plurality of second internal transmission lines may have a first property impedance and a predetermined electrical length, and the first input transmission line, the second input transmission line, and each of the plurality of output transmission lines may have a second property impedance larger than the first property impedance.

The first property impedance may be twice larger than the second property impedance, and the predetermined electrical length may be 90°.

The first signal may be a signal corresponding to a right-handed circular polarization, and the second signal may be a signal corresponding to a left-handed circular polarization.

At least one output port of the plurality of output ports may be positioned between the first input port and the second input port.

According to at least an exemplary embodiment of the exemplary embodiments, a dual-orthogonal circular polarization can be generated through a single feed network.

According to at least an exemplary embodiment of the exemplary embodiments, a dual-orthogonal circular polarization having a high antenna gain and an axial ratio property can be generated.

### BRIEF DESCRIPTION OF THE DRAWINGS

FIG. 1 is a block diagram illustrating an antenna apparatus according to an exemplary embodiment.

FIG. 2 is a block diagram illustrating an internal configuration of a feed network according to an exemplary embodiment.

FIGS. 3A to 3C are diagrams illustrating an implementation example of an antenna apparatus according to an exemplary embodiment.

FIG. 4 is a graph showing a simulation result for an input return loss and inter-port isolation property of an antenna system according to an exemplary embodiment.

FIGS. 5A and 5B are graphs showing a simulation result for a 2D radiation pattern property of an antenna system according to an exemplary embodiment.

FIGS. 6A and 6B are graphs showing a simulation result for an axial ratio property of an antenna system according to an exemplary embodiment.

### DETAILED DESCRIPTION OF THE EMBODIMENTS

Hereinafter, exemplary embodiments of the present invention will be described in detail so as to be easily implemented by those skilled in the art, with reference to the accompanying drawings. The drawings and description are to be regarded as illustrative in nature and not restrictive. Like reference numerals designate like elements throughout the specification. Further, it is to be understood that the accompanying drawings are just used for easily understanding the exemplary embodiments disclosed in this specification and a technical spirit disclosed in this specification is not limited by the accompanying drawings and all changes, equivalents, or substitutes included in the spirit and the technical scope of the present invention are included.

Terms including an ordinary number, such as first and second, are used for describing various elements, but the elements are not limited by the terms. The terms are used only to discriminate one element from another element.

It should be understood that, when it is described that a component is “connected to” or “accesses” another component, the component may be directly connected to or access the other component or a third component may be present therebetween. In contrast, when it is described that a component is “directly connected to” or “directly accesses” another component, it is understood that no element is present between the element and another element.

Through the specification, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance. Accordingly, unless explicitly described to the contrary, the word “comprise” and variations such as “comprises” or “comprising”, will be understood to imply the inclusion of stated elements but not the exclusion of any other elements.

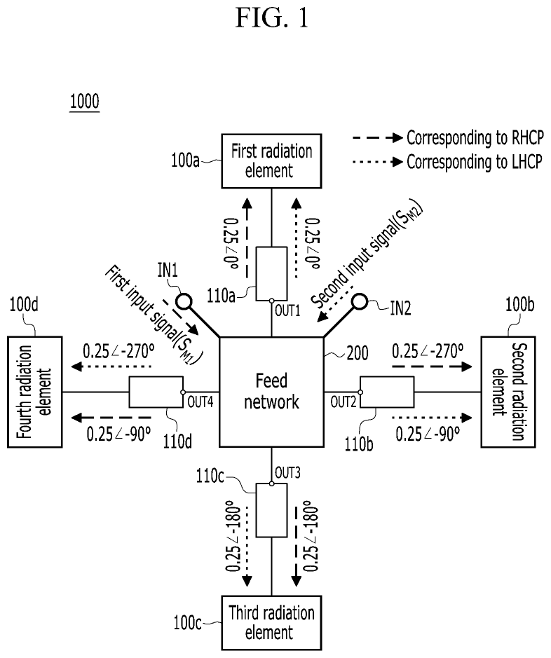

FIG. 1 is a block diagram illustrating an antenna apparatus according to an exemplary embodiment.

As illustrated in FIG. 1, an antenna apparatus 100 according to an exemplary embodiment may include first to fourth radiation elements 100a to 100d, first to fourth transmission lines 110a to 100d, and a feed network 200.

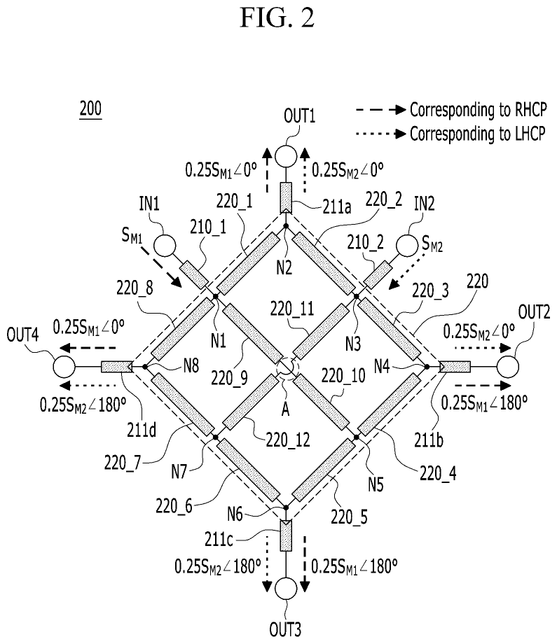

The feed network 200 may include two input ports IN1 and IN2, and four output ports OUT1, OUT2, OUT3, and OUT4. A first input signal corresponding to right-handed circular polarization may be input into a first input port IN1, and a second input signal corresponding to left-handed circular polarization may be input into a second input port IN2. Here, a first input signal S_{M1} input into the first input port IN1 and a second input signal S_{M2} input into the second input port IN2 are orthogonal and isolated from each other. As illustrated in FIG. 1, the first output port OUT1 may be positioned between the first input port IN1 and the second input port IN2. As one example the ports of the feed network 200 may be arranged clockwise in an order of the first input port IN1, the first output port OUT1, the second input port IN2, the second output port OUT2, the third output port OUT3, and the fourth output port OUT4. The feed network 200 having such a structure may be a plane type 6-port feed network. A detailed internal configuration of the feed network 200 will be described in detail in FIG. 2 below.

The first to fourth radiation elements 100a to 100d may be radiation elements generating linear polarization. The first to fourth radiation elements 100a to 100d may be positioned around (outside) the feed network 200. The first radiation element 100a may be positioned on a first lateral surface of the feed network 200 and the second radiation element 100b may be positioned on a second lateral surface of the feed network 200. In addition, the third radiation element 100c may be positioned on a third lateral surface of the feed network 200 and the fourth radiation element 100d may be positioned on a fourth lateral surface of the feed network 200. That is, the first to fourth radiation elements 100a to 100d may be positioned in order clockwise based on the first input port IN1. Each of the first to fourth radiation elements 100a to 100d may be implemented as a dipole radiation element.

The first transmission line 110a may be connected between the first output port OUT1 and the first radiation element 100a of the feed network 200, and the second transmission line 110b may be connected between the second output port OUT2 and the second radiation element 100b of the feed network 200. In addition, the third transmission line 110c may be connected between the third output port OUT3 and the third radiation element 100c of the feed network 200, and the fourth transmission line 110d may be connected between the fourth output port OUT4 and the fourth radiation element 100d of the feed network 200. Each of the first transmission line 110a and the third transmission line 110c may be a transmission line having a phase delay of 0°. In addition, each of the second transmission line 110b and the fourth transmission line 110d may be a transmission line having a phase delay of 90°.

Signals radiated from the first to fourth radiation elements 100a to 100d to a free space are spatially combined with each other, and therefore, right-handed circular polarization (RHCP) and left-handed circular polarization (LHCP) may be generated. That is, the first to fourth radiation elements 100a to 100d may generate the right-handed circular polarization (RHCP) in response to the first input signal S_{M1} input into the first input port IN1 of the feed network 200. In addition, the first to fourth radiation elements 100a to 100d may generate the left-handed circular polarization (LHCP) in response to the second input signal S_{M2} input into the second input port IN2 of the feed network 200.

FIG. 2 is a block diagram illustrating an internal configuration of a feed network 200 according to an exemplary embodiment.

As illustrated in FIG. 2, a feed network 200 according to an exemplary embodiment may include two input ports IN1 and IN2, and four output ports OUT1, OUT2, OUT3, and OUT4. The first input port IN1 and the second input port IN2 may have a high isolation property from each other, and the first to fourth output ports OUT1, OUT2, OUT3, and OUT4 may also have the high isolation property from each other.

The feed network 200 according to an exemplary embodiment may include first and second input transmission lines 210_1 and 210_2, first to fourth output transmission lines 211a to 211d, and a plurality of internal transmission lines 220.

One end of the first input transmission line 210_1 may correspond to the first input port IN1 and one end of the second input transmission line 210_2 may correspond to the second input port IN2. Ends of the respective first to fourth output transmission lines 211a to 211d may correspond to the first to fourth output ports OUT1 to OUT4, respectively. Each of the first and second input transmission lines 210_1 and 210_2 may have a characteristic impedance Z₀ and an electrical length θ₀. In addition, each of the first to fourth output transmission lines 211a to 211d may also have the characteristic impedance Z₀ and the electrical length θ₀.

A plurality of internal transmission lines 220 may include first to twelfth internal transmission lines 220_1 to 220_12. Each of the first to twelfth internal transmission lines 220_1 to 220_12 may also have a property impedance Z₁ and an electrical length 90°. Here, the characteristic impedances Z₁ and Z₀ may satisfy a relationship of Equation 1 below.

Z₁=2*Z₀ (Equation 1)

That is, characteristic impedances of the internal transmission lines 220_1 to 220_12 may have values which are twice larger than the characteristic impedances of the input and output transmission lines 210_1 and 210_2, and 211a to 211d. When the impedances of the input and output transmission lines are 50 ohms (Ω), the impedances of the internal transmission lines are 10 ohms (Ω).

The ninth to twelfth internal transmission lines 220_9 to 220_12 may be arranged in a cross form based on the center of the feed network 200. In addition, the first to eighth internal transmission lines 220_1 to 220_8 may be arranged in a ring form around the ninth to twelfth internal transmission lines 220_9 to 220_12.

In FIG. 2, a point where at least one transmission line of the input transmission lines 210_1 and 210_2 and the output transmission lines 211a to 211d and at least one transmission line of the internal transmission lines 220_1 to 220_12 are connected to each other is represented as contacts N1 to N8. The first input transmission line 210_1, the first internal transmission line 220_1, the eighth internal transmission line 220_8, and the ninth internal transmission line 220_9 may be connected to each other through the contact N1. The first output transmission line 211a, the first internal transmission line 220_1, and the second internal transmission line 220_2 may be connected to each other through the contact N2. The second input transmission line 210_2, the second internal transmission line 220_2, the third internal transmission line 220_3, and the eleventh internal transmission line 220_11 may be connected to each other through the contact N3. The second output transmission line 211b, the third internal transmission line 220_3, and the fourth internal transmission line 220_4 may be connected to each other through the contact N4. The fourth internal transmission line 220_4, the fifth internal transmission line 220_5, and the tenth internal transmission line 220_10 may be connected to each other through the contact N5. The third output transmission line 211c, the fifth internal transmission line 220_5, and the sixth internal transmission line 220_6 may be connected to each other through the contact N6. The sixth internal transmission line 220_6, the seventh internal transmission line 220_7, and the twelfth internal transmission line 220_12 may be connected to each other through the contact N7. The fourth output transmission line 211d, the seventh internal transmission line 220_7, and the eighth internal transmission line 220_8 may be connected to each other through the contact N8. Further, the ninth internal transmission line 220_9 and the tenth internal transmission line 220_10 may be connected to each other, and the eleventh internal transmission line 220_11 and the twelfth internal transmission line 220_12 may be connected to each other. Contrary to this, the ninth and tenth internal transmission lines 220_9 and 220_10 and the eleventh and twelfth internal transmission lines 220_11 and 220_12 are cross while not being connected to each other (that is, connected to each other by RF crossover). Such a cross area is represented as A in FIG. 2.

In the feed network 200 having such a configuration and such a connection relationship, signals output from the first to fourth output ports OUT1 to OUT4 may have the same amplitude property and a phase difference of 180° from each other. A relationship of the signals in the case of the first input signal S_{M1} and the second input signal S_{M2} is as follows.

First, a case where the first input signal S_{M1} is input into the first input port IN1 will be described. As illustrated in FIG. 2, the signal output from the first output port OUT1 and the signal output from the fourth output port OUT4 have the same magnitude as each other and also have the same phase difference. In addition, the signal output from the second output port OUT2 and the signal output from the third output port OUT3 have the same magnitude as each other and also have the same phase difference. Contrary to this, the signal output from the first output port OUT1 and the signal output from the second output port OUT2 have the same magnitude as each other, but have a phase difference of 180°.

Next, a case where the second input signal S_{M2} is input into the second input port IN2 will be described. As illustrated in FIG. 2, the signal output from the first output port OUT1 and the signal output from the second output port OUT2 have the same magnitude as each other and also have the same phase difference. In addition, the signal output from the third output port OUT2 and the signal output from the fourth output port OUT4 have the same magnitude as each other and also have the same phase difference. Contrary to this, the signal output from the first output port OUT1 and the signal output from the third output port OUT3 have the same magnitude as each other, but have the phase difference of 180°.

Relationships of the signals output from the first to fourth output ports OUT1 to OUT4 are organized in response to the first input signal S_{M1} and the second input signal S_{M2} are shown in Table 1 below.

TABLE 1

| Input port | OUT1 | OUT2 | OUT3 | OUT4 |
|---|---|---|---|---|
| IN1(S_{M1}) | 0.25S_{M1}∠0° | 0.25S_{M1}∠−180° | 0.25S_{M1}∠−180° | 0.25S_{M1}∠0° |
| IN2(S_{M2}) | 0.25S_{M2}∠0° | 0.25S_{M2}∠0° | 0.25S_{M2}∠−180° | 0.25S_{M2}∠−180° |

Meanwhile, as described in FIG. 1 above, each of the first transmission line 110a and the third transmission line 110c may have a phase delay of 0° and each of the second transmission line 110b and the fourth transmission line 110d may have a phase delay of 90°. The signals input into the radiation elements 100a to 100d are represented as arrows in FIG. 1 by considering the relationship in Table 1 above and the properties of the first to fourth transmission lines 110a to 110d of the feed network 200.

Referring to FIG. 1, when the first input signal S_{M1} is input into the first input port IN1, signals having the same amplitude and the phase delay of 90° from each other are fed to the fourth, third, second, and first radiation elements 100d, 100c, 100b, and 100d, respectively. That is, the signals having the phase delay of 90° counterclockwise are fed to the fourth, third, second, and first radiation elements 100d, 100c, 100b, and 100d, respectively. As a result, the first to fourth radiation elements 100a to 100d generate the radiation signal of the right-handed circular polarization in the free space.

Referring to FIG. 1, when the second input signal S_{M2} is input into the second input port IN2, the signals having the same amplitude and the phase delay of 90° from each other are fed to the second, third, fourth, and first radiation elements 100b, 100c, 100d, and 100a, respectively. That is, the signals having the phase delay of 90° clockwise are fed to the second, third, fourth, and first radiation elements 100b, 100c, 100d, and 100a, respectively. As a result, the first to fourth radiation elements 100a to 100d generates the radiation signal of the left-handed circular polarization in the free space.

Since the arrangement interval of the first to fourth radiation elements 100a to 100d generating the linear polarization is related to a gain property of an entire antenna apparatus 1000, mutual combination properties among elements, and a size (or volume) of the entire antenna apparatus 1000, the arrangement interval may be optimally determined according to a required specification of the antenna apparatus 1000.

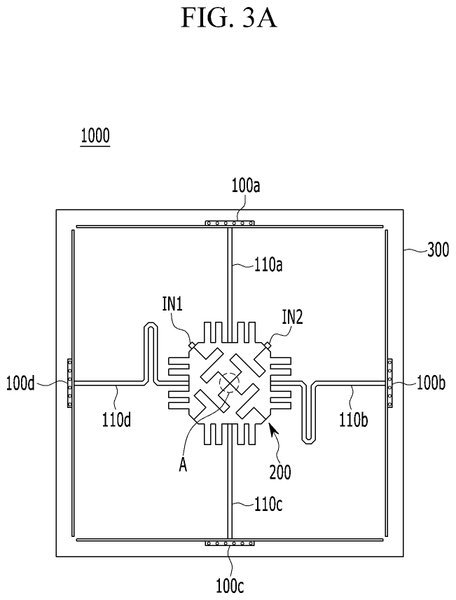

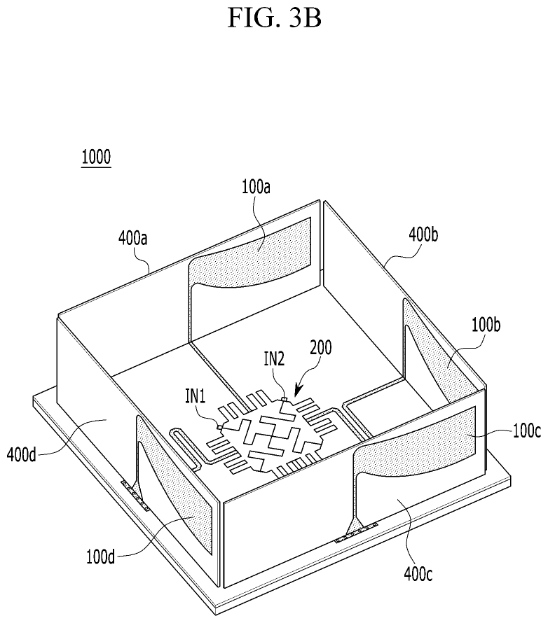

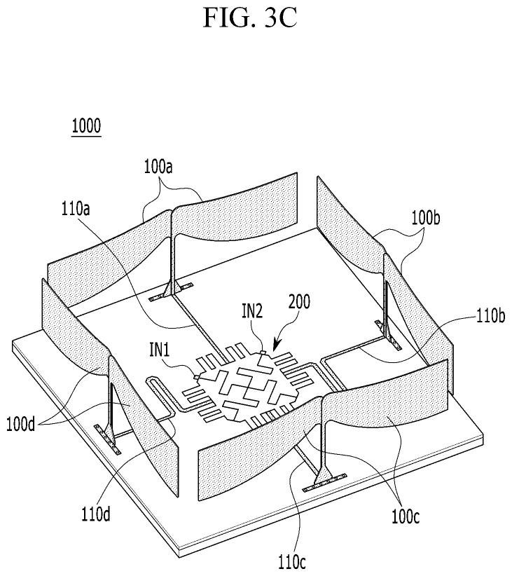

FIGS. 3A to 3C are diagrams illustrating an implementation example of an antenna apparatus according to an exemplary embodiment. FIG. 3A is a plan view of an antenna apparatus 1000 according to an exemplary embodiment and FIG. 3B is a perspective view of an antenna apparatus 1000 according to an exemplary embodiment. In addition, FIG. 3C illustrates that a substrate where the radiation elements 100a to 100d are formed is removed in FIG. 3B.

Referring to FIG. 3A, the feed network 200 and the first to fourth transmission lines 110a to 110d may be formed on a substrate 300. The substrate 300 may be a printed circuit board (PCB) and the feed network 200 to the first to fourth transmission lines 110a to 110d may be printed on the printed circuit board 300. Meanwhile, the feeding to the first to fourth radiation elements 100a to 100d may form a Balun circuit configured by a microstrip-to-strip line.

Referring to FIG. 3B, the first to fourth radiation elements 100a to 100d may be formed on substrates 400a to 400d, respectively. The substrates 400a to 400d may also be the printed circuit boards, and the first to fourth radiation elements 100a to 100d may be printed on the printed circuit boards, respectively. That is, the first to fourth radiation elements 100a to 100d may be printed dipole elements. Meanwhile, referring to FIGS. 3B and 3C, the first to fourth radiation elements 100a to 100d may be printed on both surfaces of the printed circuit boards, respectively. Referring to FIG. 3B, a substrate 400a may be formed by being erected perpendicular to the substrate 300 on a first lateral surface of the feed network 200, and a substrate 400b may be formed by being erected perpendicularly to the substrate 300 on a second lateral surface of the feed network 200. In addition, a substrate 400c may be formed by being erected perpendicular to the substrate 300 on a third lateral surface of the feed network 200, and a substrate 400d may be formed by being erected perpendicularly to the substrate 300 on a fourth lateral surface of the feed network 200. That is, the substrate 300 and the substrates 400a to 400d may form a rectangular parallelepiped structure. The first to fourth radiation elements 100a to 100d may provide maximum radiation properties in vertical directions of the substrates 400a to 400d, respectively. As a result, the antenna apparatus 1000 having the structures of FIGS. 3A to 3C may provide a high antenna gain compared with a limited space (antenna size). Meanwhile, in order to provide additional antenna directivity or gain, parasitic elements of a multi-layer conduct arrangement structure may be attached to upper portions of the first to fourth radiation elements 100a to 100d.

Referring to FIGS. 3B and 3C, each of the first to fourth radiation elements 100a to 100d may be disposed while rotating at 90° around the feed network 200. In addition, as described in FIGS. 1 and 2 above, after the first input signal S_{M1} or the second input signal S_{M2} are distributed with the same amplitude through the feed network 200, the phase delay occurs due to the first to fourth transmission lines 110a to 110d. As a result, the signals radiated by the first to fourth radiation elements 100a to 100d generate orthogonal circular polarization. The antenna apparatus 1000 according to an exemplary embodiment may provide an excellent axial ratio property by referring to a simulation result described below.

The substrate 300 and the substrates 400a to 400d may be implemented by using a TRF-45 substrate (a dielectric constant Er=4.5, a dielectric thickness H=0.61 mm, an operating thickness T=0.018, and a loss tangent tan δ=0.003@1.9 GHz) of Taconic. Operating bands of the first to fourth radiation elements 100a to 100d may be set as a GPS band. The feed network 200 and the first to fourth transmission lines 110a to 110d may be implemented as a non-combination meander line in order to reduce a circuit size. In an area A where the ninth and tenth internal transmission lines 220_9 and 220_10 and the eleventh and twelfth internal transmission lines 220_11 and 220_12 are not connected to each other, but cross, an operating frequency is low and a wavelength becomes thus larger, and as a result, the area A may be implemented as a short wire line of 1 mm (0.005λ₀). Meanwhile, referring to FIGS. 3B and 3C, the first to fourth radiation elements 100a to 100d and the first to fourth transmission lines 110a to 110d may be vertically connected to each other, and a 1:1 impedance Balun circuit (50Ω unbalance line⇒50Ω balance line) may be used for inputs of the first to fourth radiation elements 100a to 100d. A vertical and horizontal interval of the radiation elements 100a to 100d may be 76.6 mm (0.4λ₀) and a total size of the antenna apparatus 100 may be 86 (W)×86 (L)×40 (H) mm or less.

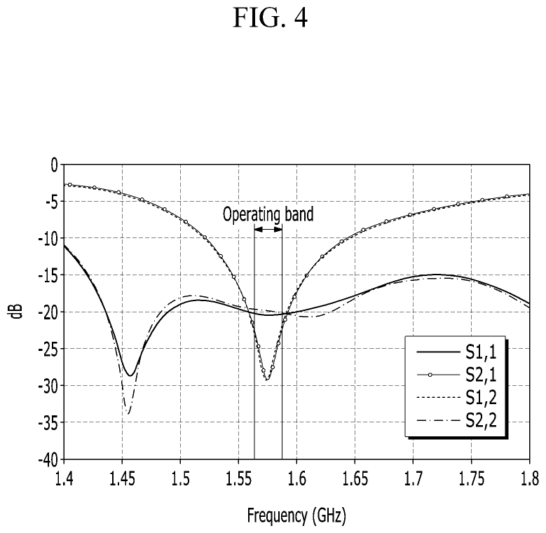

FIG. 4 is a graph showing a simulation result for input return loss and inter-port separation characteristics of an antenna system according to an exemplary embodiment.

Referring to FIG. 4, input return loss (S1,1 parameter) shows an excellent property of 19.6 dB or more at an operating frequency band (1575.42±12 MHz). In addition, an inter-port isolation property (S2,1 or S1,2) shows an excellent property of 21.7 dB or more at the operating frequency band (1575.42±12 MHz). Since a reflection property by input port mismatch of each radiation element is delivered to an orthogonal port, a frequency band property of the inter-port isolation property largely depends on a frequency band property of a unit radiation element.

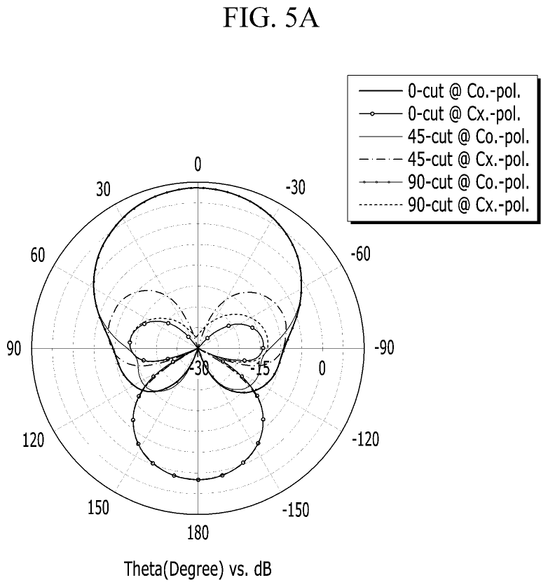

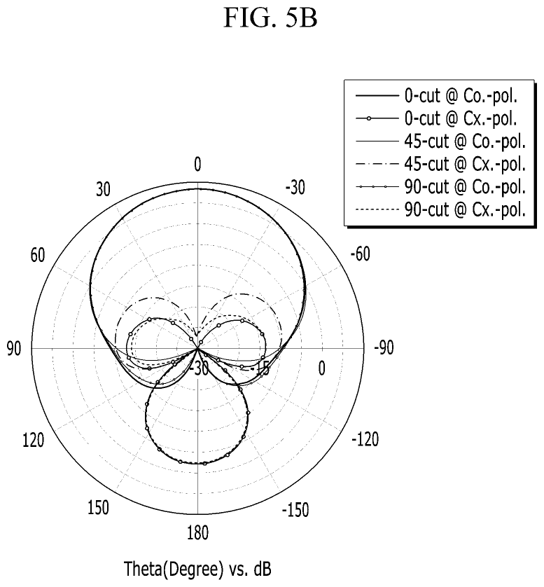

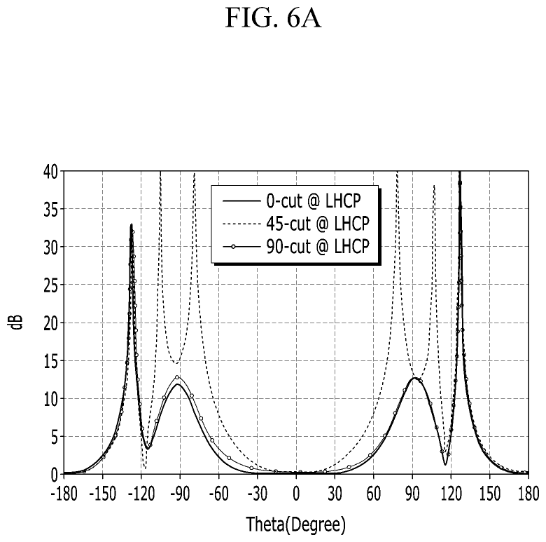

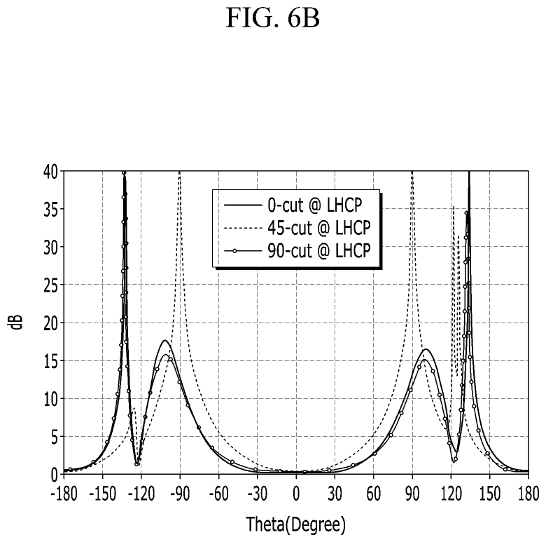

FIGS. 5A and 5B are graphs showing a simulation result for 2D radiation pattern characteristics of an antenna system according to an exemplary embodiment. In addition, FIGS. 6A and 6B are graphs showing a simulation result for an axial ratio property of an antenna system according to an exemplary embodiment.

FIGS. 5A and 6A illustrate a simulation result corresponding to the left-handed circular polarization and FIGS. 5B and 6B illustrate a simulation result for the right-handed circular polarization. Meanwhile, in the simulations of FIGS. 5A, 5B, 6A, and 6B, a center frequency is set to 1.57542 GHz.

Referring to FIGS. 5A and 5B, the antenna gain at the center frequency (1.57542 GHz) shows 8.2 dBi or more in a forward direction. Referring to FIGS. 6A and 6B, the axial ratio property of the dual-orthogonal circular polarization is 0.43 dB or less in the forward direction and shows an excellent property as 1.8 dB within a beam width of 3 dB. The results are results shown by the feed network structure and the radiation elements according to an exemplary embodiment, and are results shown when main polarization and cross polarization properties are mutually reinforced and offset.

In Table 2 below, the main radiation property parameter of the antenna in the simulation is organized. Here, the radiation property parameter may include the antenna gain, a beam width of 3 dB, and the axial ratio property.

TABLE 2

| | | | | Axial ratio |
|---|---|---|---|---|
| | | | | property |
| | | Antenna | 3 dB beam | @Forward |
| Frequency/Item | Polarization | gain | width [0°/90°] | direction |
| 1.56342 GHz | RHCP | 8.20 dBi | 70.7°/70.6° | 0.22 dB |
| | LHCP | 8.22 dBi | 66.8°/66.8° | 0.31 dB |
| 1.57542 GHz | RHCP | 8.23 dBi | 70.7°/70.6° | 0.30 dB |
| | LHCP | 8.28 dBi | 66.9°/66.9° | 0.30 dB |
| 1.58742 GHz | RHCP | 8.22 dBi | 70.7°/70.5° | 0.43 dB |
| | LHCP | 8.30 dBi | 67.1°/67.0° | 0.36 dB |

As such, the antenna apparatus according to an exemplary embodiment may generate independent dual-orthogonal circular polarization, and provide a high antenna gain and a high axial ratio property.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. An antenna apparatus comprising:
a feed network including a plurality of first internal transmission lines arranged in a cross form and a plurality of second internal transmission lines arranged in a ring form around the plurality of first internal transmission lines; and
a plurality of radiation elements positioned around the feed network and radiating signals fed by the feed network.

2. The antenna apparatus of claim 1, wherein:
the number of plurality of first internal transmission lines is at least 4 and the number of plurality of second internal transmission lines is at least 8, and
the number of input ports of the feed network is at least 2 and the number of output ports of the feed network is at least 4.

3. The antenna apparatus of claim 2, wherein:
each internal transmission line included in the plurality of first internal transmission lines and the plurality of second internal transmission lines has a first property impedance and a predetermined electrical length.

4. The antenna apparatus of claim 3, wherein:
the feed network further includes an input transmission line connected to the input port and an output transmission line connected to the output port.

5. The antenna apparatus of claim 4, wherein:
the input transmission line and the output transmission line have a second characteristic impedance, and
the first property impedance is twice larger than the second property impedance, and the predetermined electrical length is 90°.

6. The antenna apparatus of claim 2, wherein:
a first input signal corresponding to a right-handed circular polarization is input into a first input port of the at least two input ports, and
a second input signal corresponding to a left-handed circular polarization is input into a second input port of the at least two input ports.

7. The antenna apparatus of claim 6, wherein:
at least one output port of the at least four output ports is positioned between the first input port and the second input port.

8. The antenna apparatus of claim 2, further comprising:
wherein the number of plurality of radiation elements is at least 4,
at least four transmission lines connected to each of the at least four output ports and each of the at least four radiation elements.

9. The antenna apparatus of claim 8, wherein:
two transmission lines of the at least four transmission lines are transmission lines having a phase delay of 0° and two remaining transmission lines are transmission lines having a phase delay of 90°.

10. The antenna apparatus of claim 1, wherein:
the feed network is formed on a first printed circuit board,
the plurality of radiation elements is formed on a second printed circuit board, and
the second printed circuit board is formed to be erected perpendicular to the first printed circuit board.

11. A feed network providing feed signals to a plurality of radiation elements, comprising:
a first input port into which a first signal is input;
a second input port into which a second signal is input;
a plurality of first internal transmission lines arranged in a cross form;
a plurality of second internal transmission lines arranged around the plurality of first internal transmission lines; and
a plurality of output ports providing feed signals to the plurality of radiation elements, respectively.

12. The feed network of claim 11, wherein:
in the plurality of first internal transmission lines, an internal transmission line corresponding to one line and an internal transmission line corresponding to the remaining line constituting the cross form are not connected to each other, but cross.

13. The feed network of claim 11, wherein:
the number of plurality of first internal transmission line is at least 4 and the number of plurality of second internal transmission lines is at least 8,
the number of plurality of output ports is at least 4, and
the number of plurality of radiation elements is at least 4.

14. The feed network of claim 11, further comprising:
a first input transmission line connected to the first input port;
a second input transmission line connected to the second input port; and
a plurality of output transmission lines connected to the plurality of output ports, respectively.

15. The feed network of claim 14, wherein:
each internal transmission line included in the plurality of first internal transmission lines and the plurality of second internal transmission lines has a first property impedance and a predetermined electrical length, and
the first input transmission line, the second input transmission line, and each of the plurality of output transmission lines have a second property impedance larger than the first property impedance.

16. The feed network of claim 15, wherein:
the first property impedance is twice larger than the second property impedance, and the predetermined electrical length is 90°.

17. The feed network of claim 11, wherein:
the first signal is a signal corresponding to a right-handed circular polarization, and
the second signal is a signal corresponding to a left-handed circular polarization.

18. The feed network of claim 17, wherein:
at least one output port of the plurality of output ports is positioned between the first input port and the second input port.
